(19) United States
(12) Patent Application Publication
(10) Pub. No.: US 2019/0106990 A1
(43) Pub. Date: Apr. 11, 2019

(54) HYBRID COMPONENTS WITH INTERNAL COOLING CHANNELS

(71) Applicant: Siemens Aktiengesellschaft, München (DE)

(72) Inventors: Ramesh Subramanian, Oviedo, FL (US); Walter H. Marussich, Palm Beach Gardens, FL (US); Robert J. McClelland, Palm City, FL (US); Derek Bradchulis, Jupiter, FL (US); Stefan Lampenscherf, Poing (DE)

(21) Appl. No.: 16/085,236

(22) PCT Filed: Apr. 13, 2016
(86) PCT No.: PCT/US2016/027282

§ 371 Date: Sep. 14, 2018

(51) Int. Cl. F01D 5/14; B32B 3/26; B32B 3/06; B32B 3/08; B32B 5/26; B23P 15/04; C04B 37/02; C04B 37/00; F01D 5/18; F01D 5/28

(52) U.S. Cl. CPC F01D 5/147; F05D 2240/30; B32B 3/06; B32B 3/08; B32B 5/26; B23P 15/04; C04B 37/021; C04B 37/001; F01D 5/187; F01D 5/282; F01D 5/284; B32B 2260/023; B32B 2260/04; B32B 2262/105; B32B 2603/00; B23P 2700/06; C04B 2237/40; C04B 2237/38; C04B 2237/62; F05D 2230/51; F05D 2300/603; F05D 2230/60; B32B 3/266

(57) ABSTRACT

There is provided a component formed from a plurality of laminates stacked on one another, thereby defining a stacked laminate structure having a leading edge and a trailing edge. Each of the plurality of laminates is formed from a ceramic matrix composite material. In addition, a plurality of interior cooling channels are defined within an interior of the stacked laminate structure and extend longitudinally between the leading edge and the trailing edge. A metal support structure is arranged so as to extend through first openings in the laminates and through the stacked laminate structure.

### FIELD OF THE INVENTION

The present invention relates to high temperature components and to processes for forming the high temperature components. More specifically, aspects of the present invention relate to hybrid (ceramic matrix composite (CMC) and metal) components having one or more internal cooling channels formed therein.

### BACKGROUND OF THE INVENTION

Gas turbines comprise a casing or cylinder for housing a compressor section, a combustion section, and a turbine section. A supply of air is compressed in the compressor section and directed into the combustion section. The compressed air enters the combustion inlet and is mixed with fuel. The air/fuel mixture is then combusted to produce high temperature and high pressure gas. This working gas then travels past the combustor transition and into the turbine section of the turbine.

Generally, the turbine section comprises rows of vanes which direct the working gas to the airfoil portions of the turbine blades. The working gas travels through the turbine section, causing the turbine blades to rotate, thereby turning the rotor. The rotor is also attached to the compressor section, thereby turning the compressor and also an electrical generator for producing electricity. High efficiency of a combustion turbine is achieved by heating the gas flowing through the combustion section to as high a temperature as is practical. The hot gas, however, may degrade the various metal turbine components, such as the combustor, transition ducts, vanes, ring segments, and turbine blades that it passes when flowing through the turbine.

For this reason, strategies have been developed to protect turbine components from extreme temperatures such as the development and selection of high temperature materials adapted to withstand these extreme temperatures and cooling strategies to keep the components adequately cooled during operation. State of the art superalloys with additional protective coatings are commonly used for hot gas path components of gas turbines. In view of the substantial and longstanding development in the area of superalloys, however, it figures to be extremely difficult to further increase the temperature capability of superalloys.

Further, ceramic matrix composite (CMC) materials have been developed with a resistance to temperatures up 1200° C. with higher potential temperature resistance in local non-critical areas. Still further, other CMC materials have been developed with higher temperature resistance, albeit with different engineering challenges, such as environment protection. In any case, CMC materials may include a ceramic or a ceramic matrix material, either of which hosts a plurality of reinforcing fibers. Typically, the fibers may have a predetermined orientation to provide the CMC materials with additional mechanical strength. It has been found, however, that forming turbine components from CMC materials may be challenging due to, amongst other things, the difficulty in orientating fibers at edges of the component in the complex shapes typical of many turbine components. For this reason, components formed from stacked CMC laminates have been developed. The stacked CMC laminates comprise a plurality of laminates formed from a CMC material with fibers in a desired orientation. By including a plurality of flat laminates, each having a desired fiber orientation and shape, the overall composition and shape of the component may be better controlled with increased options. Still, however, while oxide and non-oxide CMC materials can survive high temperatures, they can only do so for limited time periods in a combustion environment without being cooled since external surfaces are exposed to gas path combustion gases that are substantially hotter than 1200° C. Thus, improved cooling strategies are further needed for components formed entirely or substantially from CMC materials.

### SUMMARY

The present inventors have developed systems and processes for providing enclosed interior cooling channels within a hybrid (CMC/metal) stacked laminate structure comprising a plurality of laminates stacked on one another. As will be explained below, the hybrid structure comprises a plurality of CMC laminates stacked about a metal support structure along with embedded interior cooling channels in the CMC portion. In one aspect, the embedded interior cooling channels address the need to provide additional and significant cooling for the hybrid component. In addition, the embedded interior cooling channels reduce or eliminate leakage at the metal-ceramic interface of the hybrid component. Such leakage would occur if channels were merely cut into selected ones of the stacked laminates, and a high pressure cooling fluid (having a greater pressure than the external portion of the component) were flowed into the cooling channels.

In accordance with an aspect, there is provided a gas turbine component comprising:

a plurality of laminates stacked on one another to define a stacked laminate structure having a leading edge and a trailing edge, each of the plurality of laminates comprising a ceramic matrix composite material;

a plurality of interior cooling channels defined within an interior of the stacked laminate structure, each of the cooling channels extending longitudinally between the leading edge and the trailing edge of the stacked laminate structure; and

a metal support structure arranged so as to extend through first openings in the laminates and through the stacked laminate structure.

In accordance with another aspect, there is provided a process for forming a component comprising:

about a metal support structure, forming a stacked laminate structure having a plurality of interior cooling channels defined therein from a plurality of first and second laminates, the first and second laminates each comprising a ceramic matrix composite material, the first laminates each further comprising a cooling channel in at least one side thereof, and extending longitudinally between a leading edge and a trailing edge of the first laminates.

### BRIEF DESCRIPTION OF THE DRAWINGS

The invention is explained in the following description in view of the drawings that show:

FIG. 1 is a perspective view of a component formed from a plurality of first and second laminates and having embedded cooling channels therein in accordance with another aspect of the present invention.

FIG. 2 is a cross-sectional view of the component of FIG. 1 having embedded internal cooling channels therein.

FIG. 3 is a perspective view of an exemplary first laminate having a cooling channel formed therein in accordance with an aspect of the present invention.

FIG. 4 is a perspective view of an exemplary second laminate in accordance with an aspect of the present invention.

FIG. 5 illustrates a cross-section of a cooling channel in accordance with an aspect of the present invention.

FIG. 6 illustrates a cross-section of a cooling channel having sidewalls with a roughened surface in accordance with an aspect of the present invention.

FIG. 7-8 illustrates laminates having alignment structures therein in accordance with an aspect of the present invention.

FIG. 9 illustrates a pre-formed metal support structure in accordance with an aspect of the present invention.

FIG. 10 illustrates a biasing member between a metal support structure and the body of CMC material in accordance with an aspect of the present invention.

FIGS. 11-17 each illustrate a step in a process for making a hybrid CMC/metal component having embedded cooling channels in accordance with an aspect of the present invention.

FIG. 18 illustrates a stacked laminate structure comprising CMC laminates overlapping portions of metal support structures in accordance with an aspect of the present invention.

### DETAILED DESCRIPTION OF THE INVENTION

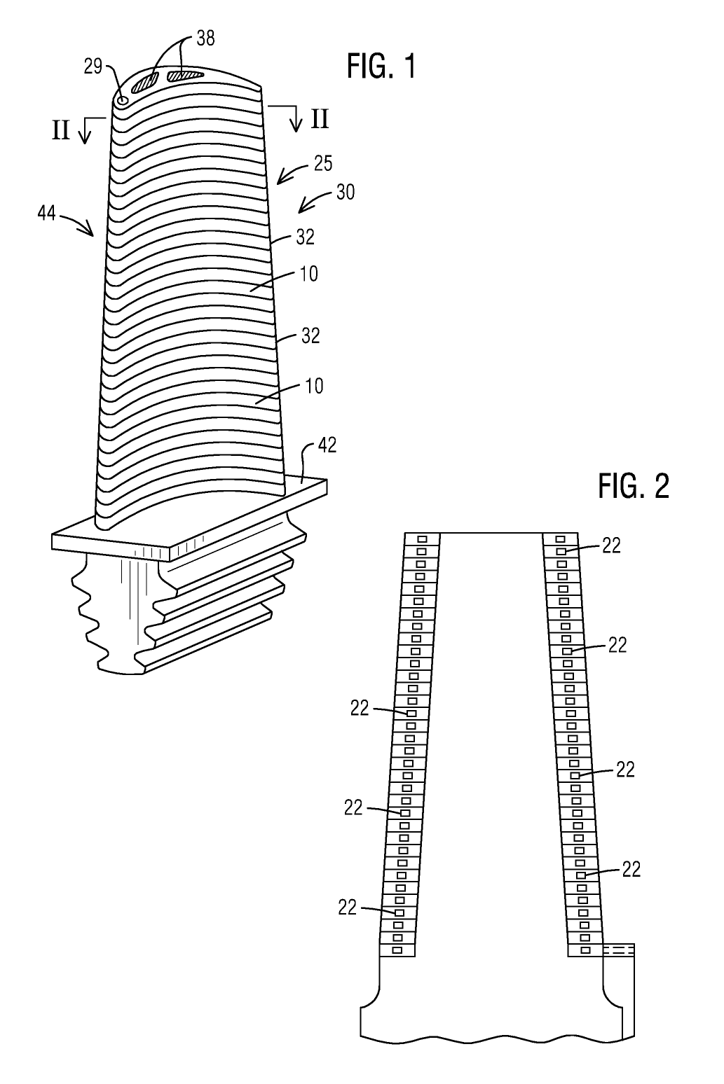

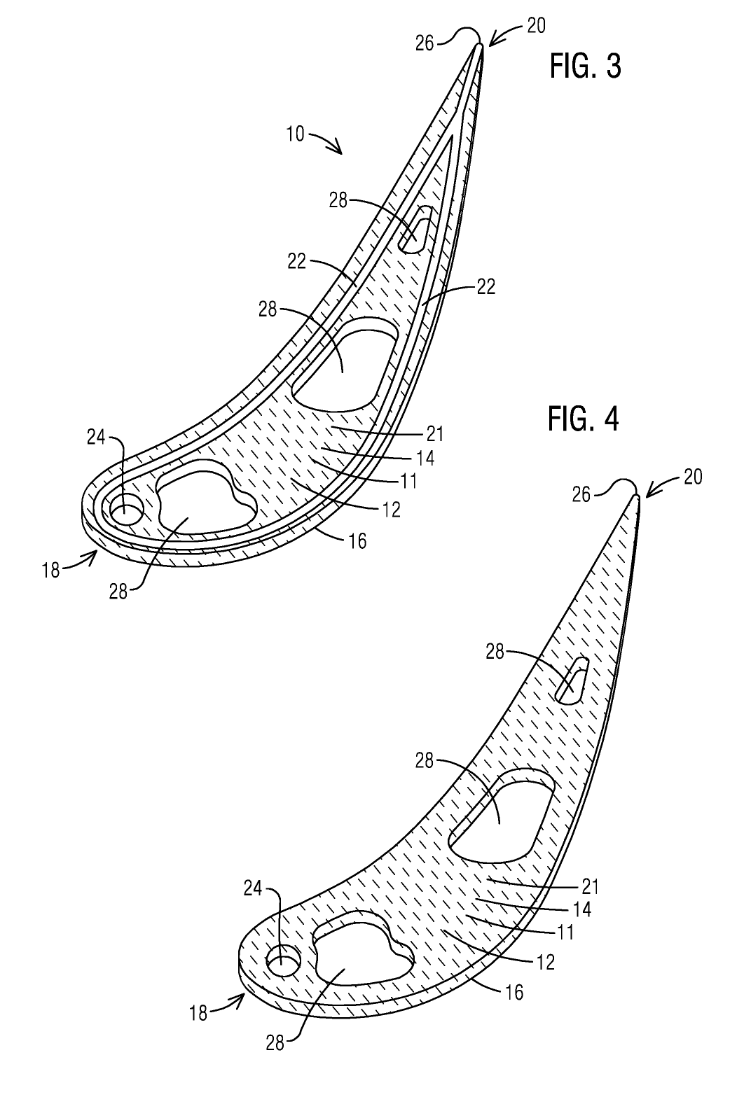

Referring now to the Figures, FIG. 1 illustrates a hybrid (CMC/metal) component 30, e.g., gas turbine blade 44, formed from a plurality of laminates 10, 32 as described herein stacked on one another to produce a stacked laminate structure 25. In one aspect, the component 30 comprises a suitable number and combination of first laminates 10 and second laminates 32 as will be explained with reference to FIGS. 3-4. Further, as shown, a metal support structure 38 extends radially through the laminates 10, 32 so as to provide added mechanical support to the CMC laminates 10, 32. FIG. 2 is a cross-sectional view of FIG. 1 (taken at line II-II of FIG. 1), and illustrates a plurality of embedded cooling channels 22 within the stacked laminate structure 25. The cooling channels 22 provide additional cooling strategies for the stacked laminate structure 25 beyond the use of the CMC material and the stacked laminates.

FIG. 3 illustrates an exemplary first laminate 10 in accordance with an aspect of the present invention comprising a ceramic matrix composite (CMC) material 11, which may be utilized in forming a hybrid component in accordance with an aspect of the present invention. In the embodiment shown, first laminate 10 comprises a body 12 having a top surface 14 and a bottom surface 16 extending between a leading edge 18 and a trailing edge 20. In addition, the first laminate 10 comprises a cooling channel 22 defined therein on or within one or both of the top surface 14 and the bottom surface 16 of the body 12. Each cooling channel 22 may extend longitudinally between the leading edge 18 and the trailing edge 20 of the laminate within an interior portion 21 of the body 12. The illustrated embodiment shows the cooling channel 22 with a uniform distance between the cooling channel 22 and an external surface or outer perimeter of first laminate 10; however, it is appreciated that the present invention is not so limited. In other embodiments, the distance between the cooling channel 22 and the external surface or outer perimeter of the first laminate 10 may vary depending on the cooling needs at the associated location of the laminate 10.

As shown in FIG. 3, in certain embodiments, the body 12 may comprise an inlet 24 for the introduction of a cooling fluid into the cooling channel 22 and an outlet 26 for exit of the cooling fluid from the channel 22. In an embodiment, the inlet 24 may be disposed at or adjacent a leading edge 18 of the first laminate 10 and the outlet 26 may be disposed at or adjacent a trailing edge 20 of the first laminate 10. The inlet 24 is at least in fluid communication with a fluid, such as air, delivered from a suitable fluid source. In addition, the first laminate 10 further includes one or more openings 28 through which a metal support structure 38 may be formed or otherwise disposed for mechanical support of the final hybrid (CMC/metal) component 30 as will be explained below.

The first laminates 10 are characterized in that they include at least one cooling channel 22 formed in a top surface 14 or a bottom surface 16 (of a longest dimension of the body), and in some embodiments are formed in both surfaces 14, 16. Moreover, the component 30 may comprise any number of internal cooling channels 22 formed therein. Similarly, while the first laminate 10 is shown with a single continuous cooling channel 22, it is appreciated that the present invention is not so limited and that each first laminate 10 may include two or more spaced apart cooling channels 22 on a selected side or surface 14, 16. In addition, although each channel 22 is shown herein with a predictable parabolic/linear path following an outer surface contour of the respective laminate, it is appreciated that the present invention is not so limited. The channels 22 may define any suitable pathway for a cooling fluid. In an embodiment, for example, certain channels 22 may define a serpentine path in and out of plane.

FIG. 4 illustrates an exemplary second laminate 32 in accordance with an aspect of the present invention also comprising a body 12 having a top surface 14 and a bottom surface 16 extending between a leading edge 18 and a trailing edge 20. In certain embodiments, the second laminates 32 also include an inlet 24 which overlies an inlet 24 of the first laminates 10 such that a cooling fluid may flow radially through the component 30 when provided thereto. In this way, the inlets 24 of each laminate 10, 32 in the stack will collectively form a plenum 29 (FIG. 1) within which a cooling fluid may be flowed to deliver cooling fluid to each of the cooling channels 22 in the component 30.

In certain embodiments, the second laminates 32 may be identical to the first laminates. In other embodiments, the second laminates 32 may be characterized in that they have at least one side or surface that does not have a cooling channel 22 formed therein. In certain embodiments, the side without the cooling channel 22 may be stacked on the first laminate 10 and utilized to enclose a cooling channel 22. However, the present invention is not so limited. In some embodiments, a first laminate 10 and a second laminate 32 may be stacked on one another such that a cooling channel 22 of the first laminate 10 overlaps a cooling channel 22 of the second laminate to form a cooling channel 22 having a depth which represents a combined depth of the two.

In some embodiments, both surfaces 14, 16 of the second laminates 32 do not include a cooling channel 22 therein as shown in FIG. 4. In another embodiment, at least one of the top surface 14 and bottom surface 16 does not include a cooling channel. In another aspect, the second laminates 32 may have a height perpendicular to its longest dimension which is smaller than such a height of the first laminate 10. In any case, when placed on or joined with a first laminate 10, the second laminate 32 may provide a suitable structure to enclose a respective cooling channel 22 and embed the cooling channel 22 within an interior of the stacked laminate structure 25 as shown in FIG. 2.

It is appreciated that the individual first laminates 10 utilized in forming the desired component 30 may be substantially identical to other first laminates 10. The same may be true with respect to the second laminates 32. However, in certain embodiments, at least one first laminate 10 may be different from another first laminate 10 and at least one second laminate 32 may be different from another second laminate 32. For example, the difference(s) may include distinctions in thickness, size, shape, density, fiber orientation, cooling channel dimensions, porosity, and the like. In certain embodiments, any one or more of the laminates 10, 32 may be in the form of a flat plate, may have straight or curved edges, and may have an airfoil shape, for example. In other embodiments, selected pairs of the laminates 10, 32 may have non-planar abutting surfaces. Further, the first laminates 10 and the second laminates 32 may be the same, or may be distinct from one another (e.g., in terms of thickness, size, shape, density, fiber orientation, porosity, and the like).

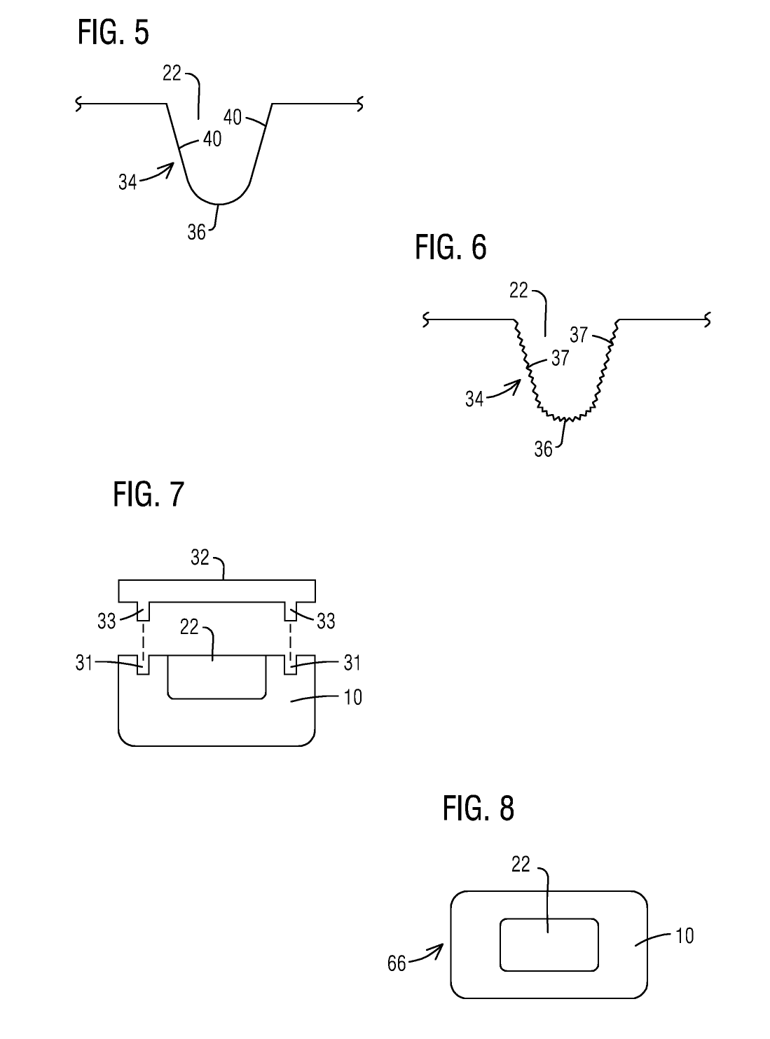

Each cooling channel 22 may be of any suitable dimension (e.g., depth and width) suitable for providing the desired degree of cooling for the component. By way of example only, each cooling channel 22 may comprises a depth of from about 0.25 to about 5 mm and a width of from about 0.25 mm to about 5 mm. As used herein, the term “about” refers to a value which may be ±10% of the stated value. In addition, each cooling channel 22 may have any desired shape in cross-section, such as a polygonal shape. In an embodiment, as shown in FIG. 5, the polygonal shape may comprise a trapezoid shape 34 in cross-section. In a more particular embodiment, the trapezoid shape 34 may comprise a rounded base portion 36 therein as shown. In other embodiments, the cooling channel cross sectional shape may be square or curved (e.g., a semicircle or a half ellipse). Further, a surface of the cooling channels 22 may have varying degrees of roughness or smoothness. In certain embodiments, one or more of the cooling channels 22 may include fins, stanchions, buttons, or the like to increase the heat transfer mechanism of the channels 22.

In addition, each cooling channel 22 may be formed in the body 12 of a first laminate 10 or second laminate 32 utilizing any suitable apparatus or process known in the art, such as via a machining apparatus or a suitable laser energy source. In certain embodiments, when a laser source is utilized to provide the cooling channel 22, the laser source may comprise a YAG laser or a carbon dioxide laser source, for example. In operation, energy may be directed from the laser source toward a selected top surface 14 or bottom surface 16 of the body 12 of the respective laminate 10, 32 in order to heat the CMC material 11 in a localized area to a temperature sufficient to cause vaporization and removal of material to a desired depth to form each channel cooling 22. It is appreciated that more than one interval (pass) may be necessary to form the channel 22 to a desired shape and dimension, as well as to provide any other desirable feature in the cooling channels 22, such as additional grooves in the side walls defining the channel 22, for example.

In another aspect, the cooling channels 22 further include any suitable additional cooling enhancement features. By way of example only, an interior surface 35 of the channel 22 may again include a roughened surface 37 as is shown in FIG. 6. The roughened surface 37 may provide for enhanced cooling or enhanced heat transfer with the cooling fluid flowing through the channel 22. The roughened surface 37 may be provided during formation by laser or milling. Alternatively, the roughened surface 37 may be provided by the addition of a trip strip as is known in the art with the channel 22. In another embodiment, the roughened surface 37 may be provided by grit blasting or any other suitable process or apparatus. In further embodiments, grooves which run parallel or at a non-parallel angle to the longitudinal length of the cooling channel 22 may be provided on either or both sidewalls 40 defining the cooling channel 22.

In another aspect, the first laminate 10 and/or second laminate 32 may have an alignment structure that facilitates positioning of a first laminate 10 and a second laminate on one another. Any suitable structure may be utilized for this purpose. Referring to FIG. 7, there is shown an exemplary first laminate 10 comprising a cooling channel 22 and with indents 31 which are dimensioned to receive corresponding tabs 33 extending from the body 12 of an exemplary second laminate 32 in accordance with an aspect of the present invention. In certain embodiments, the inverse arrangement may be provided. As shown in FIG. 8, as with any embodiment, the first laminate 10 and the second laminate 32 may be stacked on one another, and subjected to a heat treatment (fired or sintered) in order to embed the cooling channel 22 in the laminates and join the first laminate 10 to the second laminate 32 to form a laminate group 66 having an embedded cooling channel 22 therein.

As noted above, each of the first laminate 10 and the second laminate 32 may be wholly or partially formed from a CMC material 11. The CMC material 11 may include a ceramic or a ceramic matrix material, each of which hosts a plurality of reinforcing fibers. In certain embodiments, the CMC material 11 may be anisotropic, at least in the sense that it can have different strength characteristics in different directions. It is appreciated that various factors, including material selection and fiber orientation can affect the strength characteristics of a CMC material. In addition, the CMC material 11 may comprise oxide, as well as non-oxide CMC materials. In an embodiment, the CMC material 11 comprises an oxide-oxide CMC material as is known in the art.

In a particular embodiment, the CMC material 14 may comprise a ceramic matrix (e.g., alumina) and the fibers may comprise an aluminosilicate composition consisting of alumina and silica (such as 3M's Nextel 720 high temperature oxide fibers). The fibers may be provided in various forms, such as a woven fabric, blankets, unidirectional tapes, and mats. A variety of techniques are known in the art for making a CMC material and such techniques can be used in forming the CMC material 11 for use herein. In addition, exemplary CMC materials 11 are described in U.S. Pat. Nos. 8,058,191, 7,745,022, 7,153,096; 7,093,359; and 6,733,907, the entirety of each of which is hereby incorporated by reference. As mentioned, the selection of materials may not be the only factor which governs the properties of the CMC material 11 as the fiber direction may also influence the mechanical strength of the material, for example. As such, the fibers for the CMC material 11 may have any suitable orientation, such as those described in U.S. Pat. No. 7,153,096.

As mentioned, the individual laminates 10, 32 described above may be utilized to form a component 30. In one embodiment, the component 30 formed from a stack of laminates 10, 32 as described herein may comprise a stationary component for a gas turbine, such as a stationary vane, which may include an upper platform as well as the lower platform 42 shown in FIG. 1. In another embodiment, the component 30 may comprise a rotating component for a gas turbine, such as a blade 44 (FIG. 1). However, the present invention is not so limited and any desired component may be formed according to the processes described herein.

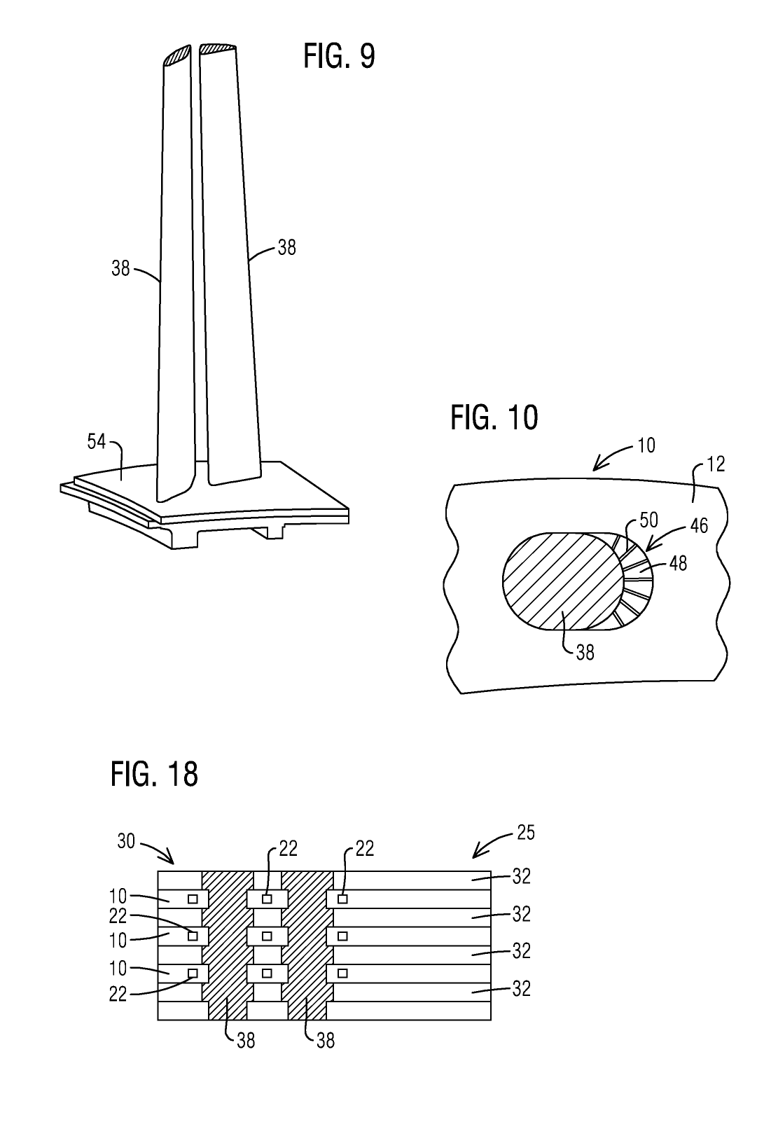

Further, when formed, the component 30 will include a metal support structure 38 which extends radially through respective openings 28 in the laminates 10,32 as shown in FIGS. 1-2, for example. Each metal support structure 38 provides a degree of mechanical support for the component. While CMC materials provide excellent thermal protection properties, the mechanical strength of CMC materials is still notably less than that of corresponding high temperature superalloy materials. For this reason, the metal support structure 38 complements the CMC material with a material having a greater mechanical strength. In certain embodiments, the laminates 10, 32 may be sequentially placed over the metal support structure(s) 34 provided like placing rings on a pole as may be seen with reference to FIG. 9. Thereafter, the laminates 10, 32 having internal cooling channels 22 formed therein may be retained/compressed via a retaining structure or other structure that compresses the stack of laminates 10, 32 and maintains the laminates in a compressed state.

In accordance with another aspect, the metal support structure 38 may be built through respective openings 28 in a stack of the CMC laminates 10, 32 on a layer by layer basis via an additive manufacturing process as individual laminates or a group of laminates are added to the stack. Exemplary additive manufacturing processes to form such a metal support structure 38 are set forth in PCT Application No. PCT/US2015/023017, entitled “Hybrid Ceramic Matrix Composite Materials,” the entirety of which is hereby incorporated by reference. An exemplary process for forming each metal support structure 38 via additive manufacturing will also be described below.

Forming the metal support structure 38 as the laminates are added provides a number of advantages. By way of example only, the additively manufactured metal support structure 38 may allow for optimized interface between the metal and CMC material at each laminate level in the stack in contrast to known methods, or allow for different CMC/metal configurations within the same component. This advantage may be particularly critical in the formation of larger components, such as gas turbine components since the larger the component, the greater the difficulty that would be expected in providing optimal interfaces between the CMC material and metal along an entire radial length of the component 30. Thus, in certain embodiments, a portion of the metal support structure 38 associated with one laminate 10, 32 may be of a different composition, shape, and dimension relative to a portion of the metal support structure associated with another distinct laminate 10, 32.

In certain embodiments, the metal support structure 38 may be configured so as to allow transfer of a load from the body 12 of the laminate 10 to the metal support structure 38. To facilitate this, in certain embodiments, the metal support structure 38 may be offset from any one or more of the laminates 10, 32 by a suitable structure which maintains a supporting force between the metal support structure 38 and the body 12 comprising the CMC material 22 yet also allows for load transfer between the metal support structure 38 and the body 12. Suitable structures to accomplish this are also set forth in PCT Application No. PCT/US2015/023017. By way of example, as shown in FIG. 10, there is provided a biasing member 46 within a gap 48 between the metal support structure 38 and a body 12 of a respective laminate (e.g., laminate) to accommodate a load transfer between the metal support structure 38 and the respective laminate, e.g., laminate 10. In addition, the presence of the biasing member 46 may allow for differential thermal expansion between the metal support structure 38 and the respective laminate 10, 32. Without limitation, the biasing member 46 may comprise a plurality of leaf springs 50 as shown or any other type of structure or material having a degree of elasticity.

In another embodiment, the biasing member 46 may comprise, for example, an additional metal portion formed by an additive manufacturing process so as to have a lattice or other structure which provides the portion with a greater degree of bias/elasticity relative to the metal support structure 38. In still another embodiment, the biasing member 46 may comprise a plurality of relatively rigid fingers (formed from metal or the like) that offset the metal support structure 38 from respective ones of the laminates 10, 32. In still other embodiments, any of the metal support structures 38 may further include a cooling channel therein, such as a cooling channel extending through an interior of the support structure along its longest dimension, wherein the cooling channel is in at least fluid communication with a suitable fluid source for delivering a fluid, e.g., air, there through.

The metal support structure 38 may comprise any suitable metal material which will provide an added strength to the laminate and/or component, as well as allow for an extent of cooling of the CMC material 11 by being in contact therewith or by being in close proximity thereto such that the CMC material 11 transfer heat to the metal support structure 38. In certain embodiments, the metal material may comprise a superalloy material, such as a Ni-based or a Co-based superalloy material as are well known in the art. The term “superalloy” may be understood to refer to a highly corrosion-resistant and oxidation-resistant alloy that exhibits excellent mechanical strength and resistance to creep even at high temperatures. Exemplary superalloy materials are commercially available and are sold under the trademarks and brand names Hastelloy, Inconel alloys (e.g., IN 738, IN 792, IN 939), Rene alloys (e.g. Rene N5, Rene 41, Rene 80, Rene 108, Rene 142, Rene 220), Haynes alloys, Mar M, CM 247, CM 247 LC, C263, 718, X-750, ECY 768, 262, X45, PWA 1483 and CMSX (e.g. CMSX-4) single crystal alloys, GTD 111, GTD 222, MGA 1400, MGA 2400, PSM 116, CMSX-8, CMSX-10, PWA 1484, IN 713C, Mar-M-200, PWA 1480, IN 100, IN 700, Udimet 600, Udimet 500 and titanium aluminide, for example.

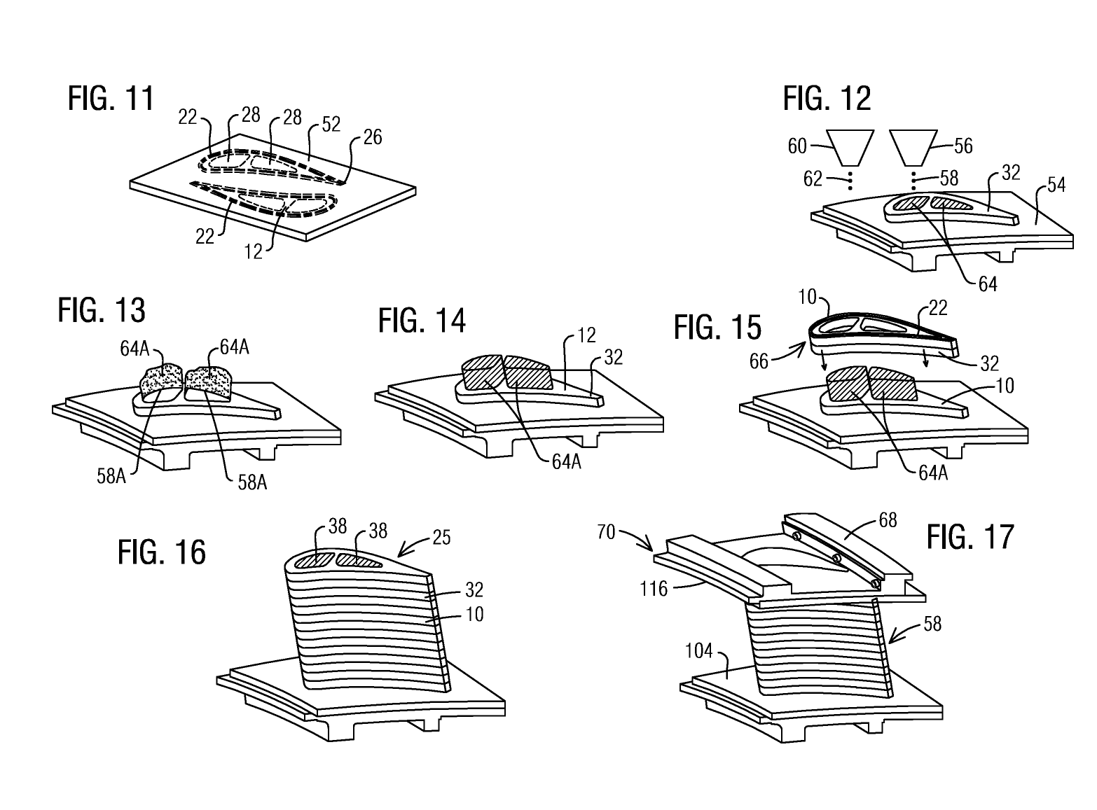

In accordance with another aspect, there are processes described herein for making the components described herein. The following description will describe exemplary processes for forming a component in accordance with an aspect of the present invention. In one embodiment, the processes may manufacture a gas turbine component as is known in the art, which may be a rotating or stationary component, such as a blade or vane. Referring now to FIGS. 11-18, a stationary vane is formed by the illustrated process, although it is understood that the present invention is not so limited to the processes described herein or the manufacture of stationary vanes or gas turbine components altogether. Alternatively, the component may comprise any other suitable article.

First, as shown in FIG. 11, a substantially flat plate 52 comprising a CMC material 11 may be provided. From the flat plate 52, the body 12 of any one or more laminates 10, 32 as described herein may be cut out to form laminates having a desired body shape (e.g., an airfoil shape) with the desired features therein. In an aspect, for example, when a first laminate 10 is to be provided, one or more of a cooling channel 22, an inlet 24, an outlet 26, and openings 28 as described herein may be formed in or through the body 12 or on the top surface 14, the bottom surface 16, or both. The formation of the laminate and its features may be accomplished by machining, water jet cutting, and/or laser cutting, or any other suitable method. In certain embodiments, a one or more of a cooling channel 22, an inlet 24, an outlet 26, and openings 28 may also be formed through the body or on the top surface 14 and/or bottom surface 16 of the second laminate 32 in the same manner as with the first laminate 10. In some embodiments, however, no cooling channel 22 is provided in the second laminate 32 and the second laminate 22 is thus formed in the same manner as the first laminate 10 without a cooling channel 22. This process step of forming the desired laminates 10, 32 can be repeated until the desired number of laminates 10, 32 of each type is formed. Of course, it may be possible to purchase the laminates 10, 32 in a pre-fabricated from a suitable source.

Forming the laminates 10, 32 from flat plates 52 can provide numerous advantages. For one, a flat plate provides a strong, reliable, and statistically consistent form of the CMC material 11. As a result, the flat plate approach may avoid manufacturing difficulties that have arisen when fabricating tightly curved configurations. For example, flat plates may be unconstrained during curing, and thus do not suffer from anisotropic shrinkage strains. Further, utilizing flat plates reduces the criticality of delamination-type flaws, which are difficult to identify. Moreover, dimensional control is more easily achieved as flat plates may be accurately formed and machined to shape using cost-effective cutting methods. A flat plate construction also enables scaleable and automated manufacturing processes. The resulting laminate structures 10, 32 from this process step are shown in FIGS. 3-4 as discussed previously.

Alternatively, the laminates 10, 32 may initially be provided by first forming a substantially flat skeleton of a desired shape instead of in the form of a substantially flat plate, while still retaining a strong, reliable, and statistically consistent form of the CMC material. The flat skeleton technique involves drawing out or purchasing commercially drawn out fiber material such as Nextel 610, 720 and 650. Depending on the particular application and desired component, the drawn fiber may have one or more certain intended thickness, size, shape, density, fiber orientation, fiber architecture, and the like. Next, the elongated drawn fiber is worked in any of a variety of ways, such as by laying up, rolling, tacking, injecting, spraying and the like, to shape out a substantially flat skeleton of a desired shape. After the flat skeleton has been shaped out, a ceramic matrix oxide material, such as that commercially available as Pritzkow FW12 (matrix is alumina zirconia mixture), or those described in U.S. Pat. Nos. 7,153,096; 7,093,359; and 6,733,907, may be deposited in and about the fiber skeleton, thereby interconnecting the fiber skeleton by any of a variety of ways, such as by injection, spraying, sputtering, melting, infiltration, melt slurry infiltration, and the like. Depending on the particular application and desired component, the resulting laminate 10, 32 comprising CMC material 11 may have one or more certain intended thickness, size, shape, density, porosity, pore characteristic and the like, if desired. Processes for carrying out this embodiment are set in forth in PCT Application No. PCT/US2015/060053, the entirety of which is incorporated by reference herein.

In addition, the substantially flat skeleton technique described above may be modified to create a thicker shape instead of a substantially flat shape. If so modified, the three dimensional skeleton shape may be generally consistent with the three dimensional shape of the desired component such as a combustion turbine vane or blade. This modification involves stacking the drawn fiber or using much thicker drawn fiber to shape out a thicker skeleton.

Referring now to FIG. 12, a base member 54 may be provided on which to stack the plurality of first laminates 10 and second laminates 32. In certain embodiments, the laminates 10, 32 are placed individually on the base member to build the stacked laminate structure. As mentioned, at selected portions of the stacked laminate structure, embedded cooling channels 22 will be formed in the stacked laminate structure 25. This may be accomplished by stacking a first laminate 10 with a second laminate 32 such that they define one or more enclosed cooling channels 22 within the laminates 10, 32. Thereafter, in certain embodiments, the laminates may undergo heat treatment, e.g., a sintering process, in order to sinter/fuse the two laminates together. In this way, the likelihood of cooling fluid loss between adjacent laminates is reduced or eliminated. In other embodiments, two or more laminates 10, 32 forming a respective internal cooling channel 22 may be sintered in a separate location (away from the stack) so as to fuse the laminates together as a laminate group 66 having two or more laminates, which may then be placed on the stack. The sintering may be done at any suitable temperature and a for a suitable duration to join two adjacent laminates to one another, and in one embodiment, may be done at a temperature of about 500 to 1000° C. for a period of 1 to 24 hours.

In this embodiment, the base member 54 may comprise a platform, e.g., a radially inward platform, for a stationary vane or blade. Alternatively, the base member 44 may be any other suitable structure, such as a second laminate 32 without any openings formed therein. In other embodiments, the base member 54 may further include a layer of metal material, which may be disposed on the platform, for example. In any case, the selected laminates 10, 32 or laminate groups 66 are placed on the base member 54 in their desired order.

In certain embodiments, one or more metal support structures 38 (or portions thereof) are provided, each of which extends radially from the base member 54 as was shown in FIG. 8. In an embodiment, the laminates 10,32 or laminate pairs are stacked sequentially as desired on the metal support structures 38 until the completed stacked laminate structure 25 is formed. In this embodiment, the metal support structure 38 may thus be pre-fabricated and dimensioned so as to accommodate placement of the laminates 10, 32 thereon.

In accordance with another aspect, the metal support structure 38 is instead build in situ via additive manufacturing as the laminates 10, 32 or laminate groups 66 are stacked to form the complete stacked laminate structure 25. Referring to FIG. 12, for example, a metal source material 58 is added to desired location(s) within the openings 28 of one or more laminates 10, 32. In an embodiment, the metal material 58 is provided from a suitable metal source 56, such as a hopper or the like, in powdered form at a predetermined volume and feed rate.

Following deposition of the metal material 58, an energy source 60, such as a laser source, focuses an amount of energy 62 on the metal material 58 within a respective opening 28 to melt a predetermined amount of the metal material 58 in a predetermined pattern according to a predetermined protocol to form molten metal within a respective opening 28. To accomplish this, the energy source 60 may be moved with respect to the subject laminate(s), or vice-versa, to position the energy source 60 at a desired location over the subject laminate(s) to melt the metal material 48. The molten metal will be allowed to cool actively or passively to provide two segments of spaced apart metal support structures 38. These portions thus may define segments 64 of respective metallic support structures 38, each of which may extend through respective openings 28 in each of the laminates 10, 32 of the stack.

In this embodiment, in order to build the metal support structures 38 and to facilitate addition of a subsequently formed portion 64A on top of a previously formed segment 64, additional metal material 58A may be added on top of the segment 64 as is shown in FIG. 13. Thereafter, the energy source 60 (FIG. 12) may again direct an amount of energy 62 to melt the additional metal material 64A and the resulting molten material may be allowed to cool (actively or passively) to form subsequently formed segment 64 as shown in FIG. 14, each of which may stand proud from a top surface of the topmost laminate in the stack at the time.

In an embodiment, the subsequently formed metal core 64A may now act as a post onto which a subsequent laminate 10, 32 or laminate group 66 (as shown) may be placed over the segment 64 as shown in FIG. 15. This process may be repeated over and over until all the full laminate stack 25 is formed as shown in FIG. 16. One advantage of this design is that various sections of the metal support structure 38 can be specifically customized for the corresponding laminate 10, 32 or group 66, and may be customized in any desired manner (e.g., size, shape, material for load or thermal transfer and/or to have a desired interface between the CMC material and the metal support structure).

By way of example only, with a stack of twenty laminates, it would be difficult to have a optimal interface between CMC material and metal support structure 38 along the entire radial length if a pre-formed, long, and rigid rod extended through the laminate stack from a radially outer end to a radially inner end thereof. In other words, the larger the structure being formed, the more difficult it would be to provide the desired specifications, such as an optimal interface between CMC material and metal, at each and every radial position of the component being formed. Thus, by utilizing additive manufacturing to build the metal support structure 38 layer by layer through the stacked laminate structure 25, dimensions/parameters of the CMC material and/or metal, the interface between the two, and any other structures in the component may be optimized at various intervals along a radial length of the component. Such customization is not possible with a long rod or the like, for example.

In accordance with another aspect, when applicable, during the formation of the metal support structure 38, the gaps 48, biasing members 46, or any other desired feature described herein may be also be incorporated or otherwise formed within the openings 28 during the additive manufacturing process. It is appreciated also that the formation of gaps 48 may take place via the use of removable spacers and/or via control of additive manufacturing parameters, such as laser intensity, duration, spacing between energy source and component, and the like.

As shown in FIG. 16, when the last laminate 10, 32 or group 66 is added to the stack, the formation of the laminate stack 25 having a plurality of cooling channels 22 formed therein is complete. Thereafter, if necessary or desired, a top member 68 may be provided to define the top surface of the component 30, which, in this case, may define a stationary vane 70 as shown in FIG. 17. In the embodiment shown, the top member 68 may comprise an outer radial platform in the case of a stationary vane. In other embodiments, such as is the case with the formation of a blade, the top member 58 may include an already formed laminate or even a laminate as described herein comprising CMC material, but without a metal core or opening.

Once all the desired laminates are stacked on one another and a top member is applied (if present), manufacturing of the component may be finished by any desired process or processes such as machining, coating, and heat treating. In certain embodiments, it may be desirable to afford greater thermal protection to the component, especially those portions which will be exposed to high temperatures. In such case, one or more layers of a thermal insulating material or a thermal barrier coating can be applied to the peripheral surface of the component 30 where desired. In one embodiment, the thermal barrier coating may comprise a friable graded insulation (FGI), which is known in the art, such as in U.S. Pat. Nos. 6,670,046 and 6,235,370, which are incorporated by reference herein. In other embodiments, such thermal barrier coatings may be applied to an outer periphery of each laminate 10, 32 prior to the stacking of the laminates 10, 32.

The above paragraphs set forth one exemplary process for producing a component 30 from a plurality of laminates 10, 32 while forming embedded internal cooling channels 22 within the component 30. However, it is understood that the present invention is not so limited. Any other suitable method for forming the component 30 described herein while enclosing the cooling channel however may be utilized. For example, the metal support structure need not stand proud of the top surface of the most recently placed laminate in the stack. In certain embodiments, the most recently formed metal portion, e.g., 64 or 64A, may be formed so at least a segment thereof is flush with the most recently placed laminate 10, 32 or laminate group 66 in the current stack. In still other embodiments, the most recently formed metal portion, e.g., 64 or 64A, may be formed such that at least a portion to be disposed below a top surface of the most recently placed laminate 10, 32 or laminate group 66 in the current stack. To reiterate, these and other methods for forming a component from a plurality of stacked laminates may be utilized in the present processes and are set forth in PCT Application No. PCT/US2015/023017, the entirety of which is hereby incorporated by reference.

In certain embodiments, the metal support structure 38 comprises a relatively symmetrical form such that the dimensions of the openings and surrounding body of adjacent laminates are relatively the same or similar throughout the component. In another embodiment, as shown in FIG. 18, the metal support structure 38 may be formed by additive manufacturing such that portions of the CMC laminates 10, 32 overlap portions of the metal support structure 38 so as to interlock the CMC laminates 10, 32 (which embed cooling channels 22) and the metallic support structure(s) 38 in the stack 25. In this way, multiple portions of the metal support structure 38 may overlap respective CMC laminate(s) 10,32, thus entrapping the CMC laminates 10, 32 via the metal support structure 38, such as in a vertical or engine radial direction. Such constructions may be useful to provide individual laminate supports to avoid separation and leakage paths (internal cooling air leaking out or hot gases leaking in) under certain loading conditions or in the event of an individual laminate fracture. Such constraint may also be applied in the case of rotating airfoils, to distribute the centrifugal loads from each laminate to the metal support structure 38. In the case of blade, this approach has advantage over the conventional spar-shell concepts which concentrate airfoil shell loads at the blade tip, thereby increasing the overall blade loading by placing the center of gravity towards the blade tip. In one aspect of the present invention, a load transfer occurs at each laminate in the stack, and thereby may reduce a centrifugal load.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.
1-8. (canceled)

9. A process for forming a component comprising:
about a metal support structure, forming a stacked laminate structure having a plurality of interior cooling channels defined therein from a plurality of first and second laminates, the first and second laminates each comprising a ceramic matrix composite material, the first laminates each further comprising a cooling channel in at least one side thereof, and extending longitudinally between a leading edge and a trailing edge of the first laminates;
wherein the metal support structure (38) is provided via melting and resolidifying successive layers of a metal material (58, 58A) before or after respective laminates (10, 32) are stacked on one another to form the component (30).

10. (canceled)

11. The process of claim 9, further comprising forming the cooling channel in each of the first laminates by laser cutting the cooling channel in at least one surface thereof.

12. The process of claim 9, wherein the interior cooling channels are formed by stacking a second laminate on a first laminate such that a top portion of the cooling channel of the first laminate is covered by the second laminate, and sintering the first and second laminate at a temperature effective to join the first laminate to the second laminate.

13. The process of claim 9, wherein the first laminate is provided with an inlet at or adjacent the leading edge and an outlet at or adjacent the trailing edge in fluid communication with the cooling channel such that a cooling fluid may be flowed into the inlet and through the cooling channel to an outlet of the first laminate.

14. The process of claim 9, further comprising providing one or more plenums extending through the stacked laminate structure, and wherein the one or more plenums are in fluid communication with the cooling channels such that a cooling fluid introduced into the one or more plenums travels into the cooling channels.

15. The process of claim 9, wherein the process forms a stationary or rotating component of a gas turbine engine.
